(19) United States
(12) Patent Application Publication
(10) Pub. No.: US 2014/0251770 A1
(43) Pub. Date: Sep. 11, 2014

(54) SWITCHING DEVICE

(71) Applicants: Lior Kogut, Haifa (IL); Boris Neoponyashchy, Haifa (IL); Avihay Ohana, Haifa (IL); Nir Pernat, Zirchron Yaakov (IL)

(72) Inventors: Lior Kogut, Haifa (IL); Boris Neoponyashchy, Haifa (IL); Avihay Ohana, Haifa (IL); Nir Pernat, Zirchron Yaakov (IL)

(21) Appl. No.: 14/235,367

(22) PCT Filed: Jul. 26, 2012
(86) PCT No.: PCT/IB2012/053808

§ 371 Date: May 7, 2014

(30) Foreign Application Priority Data
Jul. 26, 2011 (IL) 214294

(51) Int. Cl. H01H 1/00; H01H 35/14

(52) U.S. Cl. CPC H01H 1/0036; H01H 35/141
USPC 200/61.45 R

(57) ABSTRACT

An acceleration responsive switching device formed as a micro-electromechanical systems (MEMS) device in which components are deposited and etched on and or above a substrate. The device has a proof mass module. The proof mass module includes: at least one proof mass made of metal; at least three resilient suspending members made of metal, for suspending the proof mass; a lingule made of metal, connected to the proof mass; at least two contact pads to which at least one of the three resilient suspending members is permanently attached thereby allowing current to flow from the at least two pads to the proof mass module; and at least one additional contact pad, which is set against the lingule.

### CROSS REFERENCE TO RELATED APPLICATIONS

This application is a national stage entry of PCT/18201 2/053808 entitled “SWITCHING DEVICE”, filed on Jul. 26, 2012, which claims priority from Israel patent application 214294, entitled “SURFACE MICRO-MACHINED SWITCHING DEVICE”, filed on Jul. 26, 2011 the entire contents of which are incorporated herein by reference.

### FIELD OF THE INVENTION

The present invention relates to a system for on/off switching of electric circuits, in particular such devices actuated by mechanical acceleration and which are required to demonstrate a certain degree of adaptability to varying ranges of acceleration/deceleration.

### BACKGROUND OF THE INVENTION

Surface micromachining is used for the production of micro-electromechanical systems (MEMS) devices. In surface micromachining, rather than bulk micromachining, the MEMs' substrate is made of materials such as silica, alumina, glass, silicon and others.

Impact switches make or break contact when a certain mechanical activation or vibration level exceeds a certain limit.

### SUMMARY OF THE INVENTION

The present invention provides a way to manufacture such miniaturized devices that utilize surface micromachining techniques and can be so formed as to provide specific benefits.

The present invention provides an acceleration responsive switching device formed as a micro-electromechanical systems (MEMS) device in which components are deposited and etched on and or above a substrate. The device has a proof mass module. The proof mass module includes: at least one proof mass made of metal; at least three resilient suspending members made of metal, for suspending the proof mass; a lingule made of metal, connected to the proof mass; at least two contact pads to which at least one of the three resilient suspending members is permanently attached thereby allowing current to flow from the at least two pads to the proof mass module; and at least one additional contact pad, which is set against the lingule.

### BRIEF DESCRIPTION OF THE DRAWINGS

FIG. 1A is a schematic isometric view of an embodiment of an acceleration responsive switch of the present invention, featuring a perforated proof mass, and proof mass suspenders;

FIG. 1B is a schematic isometric view of an embodiment of an acceleration responsive switch featuring functionality modulating electrodes;

FIG. 2 is a schematic isometric view of a switching device of the invention showing a circular proof mass variant;

FIG. 3A is a schematic side view of a circular proof mass switch showing a constraining scheme;

FIG. 3B is a schematic side view of an axial variant of the switch showing a constraining scheme;

FIG. 4A is a schematic side view of the proof mass and the substrate illustrating a space therebetween;

FIG. 4B is a schematic side view of space between the proof mass and the substrate showing a cushion;

FIG. 4C is a schematic side view of space between the proof mass and the substrate showing the proof mass module at its lowest position;

FIG. 5A is a schematic cross sectional view of the switch of the invention at a stage in which a metal layer is deposited over an adhesive layer;

FIG. 5B is a schematic cross sectional view of a switch of the invention showing margins of the adhesive layer around a metal contact pad, after the adhesive layer is etched;

FIG. 5C is a schematic cross sectional view of the switch demonstrating over-etched margins of the adhesive layer;

FIGS. 6A-6E are schematic cross sectional views of the switch showing successive changes in the production of a proof mass element;

FIGS. 7A-7C are schematic cross sectional views of the switch showing details of the lingule and relations with the subjacent contact pad;

FIGS. 8A-8C are schematic cross sectional views of the switch showing gradual closure of the switching device upon inception of an acceleration event;

FIG. 9A is a schematic cross sectional view of a proof mass module of the switching device of the present invention showing corrugations; and

FIG. 9B is a schematic cross sectional view of a corrugated zone in a proof mass module.

### DETAILED DESCRIPTION OF THE INVENTION

In accordance with the present invention, an acceleration responsive switching device is prepared by applying surface micromachining involving deposition of layers on a substrate, typically such that one or more sacrificial layers are employed for the purpose of providing a measured vertical gap between layers or parts of layers. An acceleration responsive switching device (ASD) in accordance with the present invention includes a substrate, which will be used hereinafter as a reference for defining the relative positioning of the components of the ASD.

Structural Aspects of a Switching Component, Two Variants

In accordance with the invention, the proof mass is a mass that maintains a linear momentum proportional to its mass which is made of electrically conducting material, typically metal. It, is suspended by proof mass suspenders (PMSs), which are resilient members also made of electrically conducting material, such as metal. To the proof mass is attached a contact lingule, made of electrically conducting material as well.

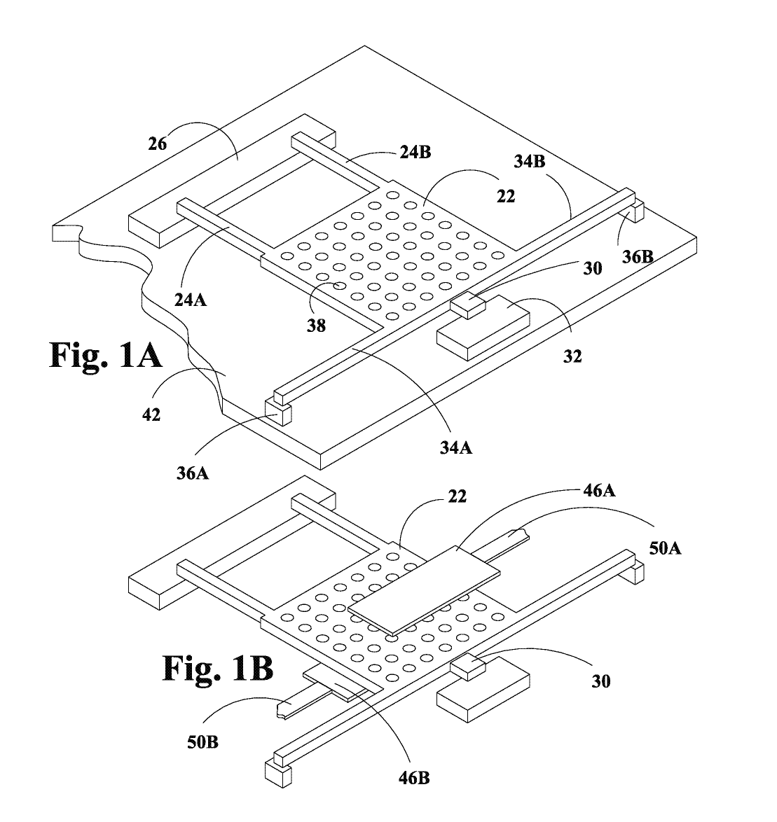

To explain the principles of the structure of an acceleration responsive switching device (ASD), reference is now made to FIGS. 1A-1B illustrating two respective variants of the switching device of the invention. In FIG. 1A, proof mass 22, is a squarish perforated plate, having through holes or perforations 38 whereby ambient gas molecules can pass from one side to the other side of the proof mass through those holes. Rear PMS 24A and rear PMS 24B extend from proof mass 22 to rear contact pad 26. Although rear contact pad 26 serves as a metal contact between the rear PMSs 24A and 24B, the rear contact pad also serves as an anchor for the rear PMSs, with respect to the substrate. On the flank of proof mass 22, opposite PMSs 24A and 24B is attached a contact lingule 30 which upon a certain mechanical acceleration occurring, is made to form a contact with a front contact pad 32. Front suspenders 34A and 34B resiliently support proof mass 22, and each of the suspenders is attached to respective anchors 36A and 36B. The ensemble of suspending components is further referred two as suspending members. A prominent feature of the proof mass 22 is the perforations 38. The role of perforations 38 is to facilitate the passage of air or any other gas from one side to the other side of proof mass 22, as the proof mass moves relative to substrate 42. In another embodiment of the invention, a bias is applied to modify the mobility features of the proof mass. As can be seen in FIG. 1B, wherein the substrate is not shown, two metal plates are disposed (referred to hereinafter as electrode/s), facing proof mass 22. Electrode 46A above and electrode 46B below proof mass 22 each suspend from a respective suspender 50A and 50B. These suspenders as well as the electrodes 46A and 46B are conductors of electricity, which is an important factor in the understanding their functionality. The role of one or two of the electrodes 46A and 46B is to modulate the mechanical function and response parameters of the proof mass and components of the switching device by forming an electric field across the proof mass, which will be elaborated below.

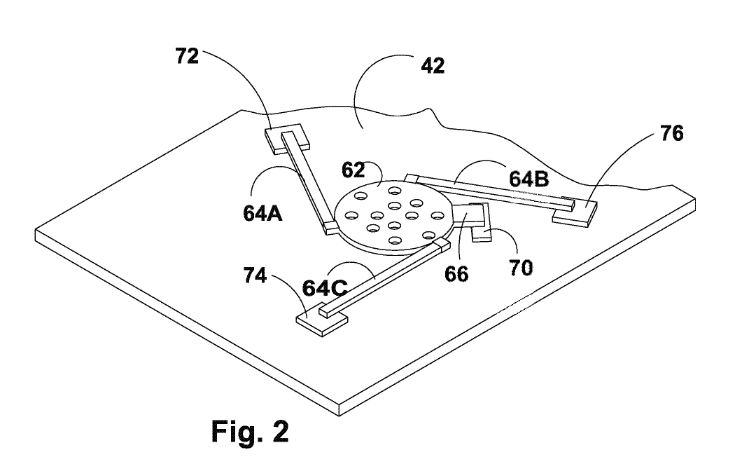

Another structural variant of the acceleration sensitive switch of the present invention is the circular variant, and in order to make a distinction between the two variants, the one described above will be hereinafter referred to as an axial variant. To explain structural aspects of the circular variant, reference is made first to FIG. 2. Proof mass 62 suspends from three PMSs 64A, 64B and 64C, which constitute the suspending members. The distribution of the suspending members around the proof mass 62 is illustrated as symmetrical but there is no absolute necessity for such an attribute. Contact lingule 66 is appended to proof mass 62 and is set against contact pad 70 so that when the proof mass is engaged with contact, a metal to metal connection is formed, namely pad 70, lingule 66 and proof mass 22 can close an electrical circuit. For this to occur, one of the PMSs 64A, 64B and 64C also must function as a metal conductor and contact, for example PMS 64A. In such a case, anchor 72 also functions as a contact pad. However anchors 74 and 76 do not function as contact pads in this example. There is no a priori limitation on the number of contacting PMSs and also no a priori limitation as to the number of anchors functioning also as contact pads, although one is usually sufficient.

Differences Between the Two Variants

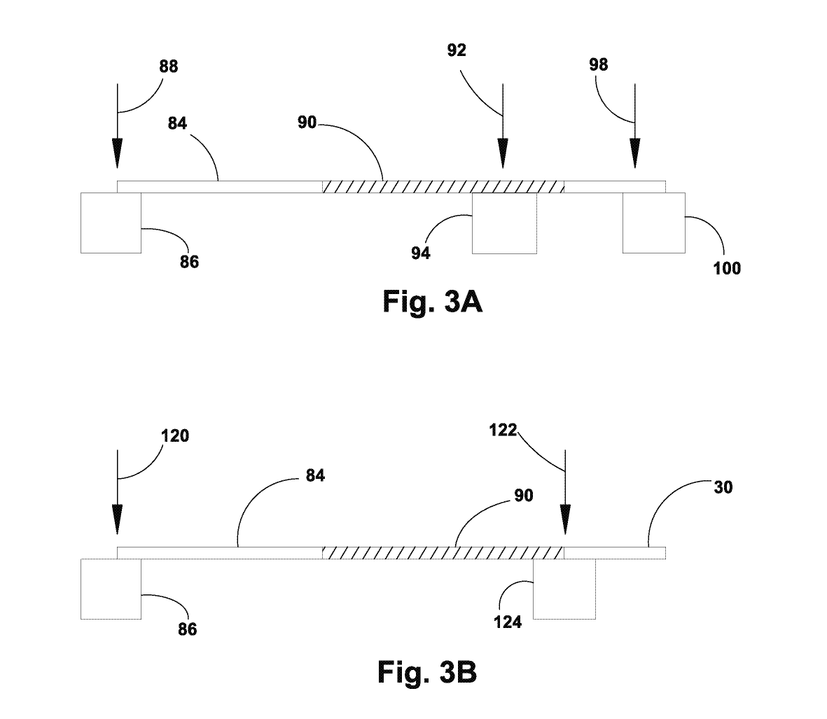

The suspending members that hold the proof mass, respectively in each case, function as constraining members. As can be realized from the description, the circular variant is circularly symmetrically constrained as regards motion, since it is encircled by three PMSs acting as constraining members. The axial variant is not circular, and in order to explain the differences reference is made to FIGS. 3A-B. In FIG. 3A, a side view of a circular acceleration-responsive switch shows PMS 84 subtended by anchor 86. The circular acceleration-responsive switch is therefore constrained at a point indicated by arrow 88. Hatched sector 90 represents the proof mass 22 which is connected to another PMS roughly at its middle, at a constraining point indicated by arrow 92, anchored at anchor 94. Another constraining point is indicated by arrow 98 which is associated with anchor 100.

In FIG. 3B the axial variant is shown constrained at one point represented by arrow 120 and a distal point indicated by arrow 122. It can be seen that the proof mass in this case is constrained at two points only, subtended by anchor 86 and 124 at their constraining points. This variant can therefore be described as axially symmetrically constrained. To justify the production of the two different variants, it is argued that the axial variant is more immune to mechanical disturbances that travel along the direction of the main axis of the proof mass. Such disturbances, which may occur as a result of mechanical forces propagating along the main axis, cannot entirely prevent contact being made between the lingule and the respective contact pad. The circular variant is rather more immune to non directional mechanical aberrations, for example such that may be caused by temperature deviation from an expected range of values. In the case of a temperature associated aberration, the circular variant is less likely to suffer loss of functionality as it is symmetrically constrained.

Modulating the Functionality of the Switching Device Applying an Electric Field

The electric field produced by the charge on the electrode/s can affect the proof mass, which may be charged as well. This modulation effect will be dealt with in more detail below. Another aspect of the electrical manipulation using the two electrodes is latching of the contact lingule, either in the “on” state or in the “off” state. Such latching can be used for example to cause the lingule 30, 66 to latch away from the electrical contact, and thus be used as a safety application in which the switch is the “off” state. This may be advantageous when the device in which the installed switch undergoes testing. Conversely, the latching effect can be used to lock the lingule 30, 66 to the electrical contact, and therefore increase the time in which the switch is turned “on” when a certain acceleration/deceleration takes place. Keeping the lingule closer to the electrical contact reduces the energy barrier preventing the lingule from attaching to the electrical contact, and vice versa for increasing the distance between the lingule and the electrical contact, which may be used to decrease the responsiveness to acceleration/deceleration. In order to prevent undesirable electric contact between the proof mass and the electrodes, a dielectric layer (not shown) may be disposed over one or both the electrodes. The implementation of an electric field across the proof mass can also bring about shortening of the response time of the switch to the activating acceleration. The reason for that is that the activating acceleration/deceleration provides a force which drives the proof mass 22 and with it the lingule to make electrical contact. With the addition of a contributory electric field, the force applied to the proof mass 22 is augmented, whereby the acceleration of the proof mass is likewise augmented.

The Space Beneath the Proof Mass

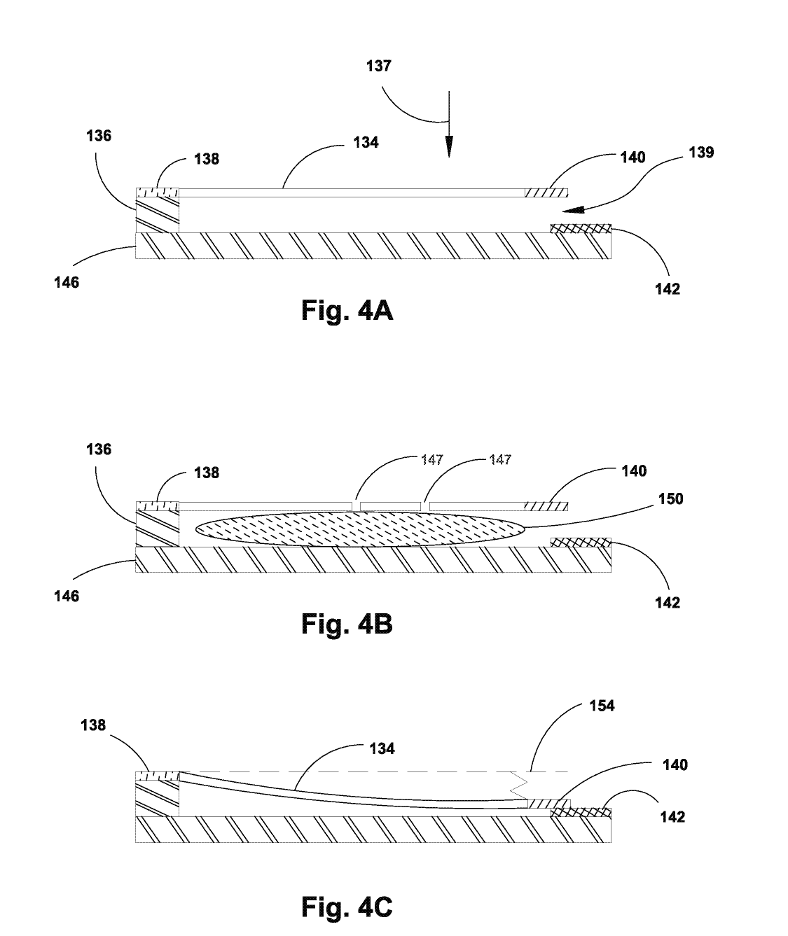

The response time of the acceleration responsive switch of the invention is a crucial feature. One phenomenon that impedes the response of the switch to the onset of an acceleration event is the viscosity of the air (or other gas) filling the space in which the switch is located. To better explain the phenomenon and the way that the present architectural principles address the problem, reference is made to FIG. 4A showing a proof mass module 134 (inclusive of PMSs and contacts). At the left side, an anchor 136 subtends contact pad 138 of proof mass module 134. Upon the onset of acceleration (or deceleration), contact lingule 140 at one extremity of proof mass module 134 moves generally downwards in the direction of arrow 137, into a sub proof mass space 139 to form contact with a contact pad 142 which sits on substrate 146. The viscosity of the gas (such as air) beneath proof mass module 134, forms a mechanically blocking zone illustrated pictorially as an elastic bubble or cushion produced by the viscosity of the gas, depicted pictorially in FIG. 4B as gas cushion 150. Gas cushion 150 can dissipate through perforations 147 in the proof mass 22 and/or through the sides.

As can be seen in FIG. 4C, when the proof mass module 134 has bent, contact lingule 140 becomes engaged with contact pad 142. Subsequently, current can flow from contact pad 138, through proof mass module 134, lingule 140 and contact pad 142, and/or backwards in the reverse direction. Line 154 marks the position of the upper edge of proof mass module 134 before it is urged by the acceleration.

Production Using Surface Micromachining

Adhesion to the Substrate

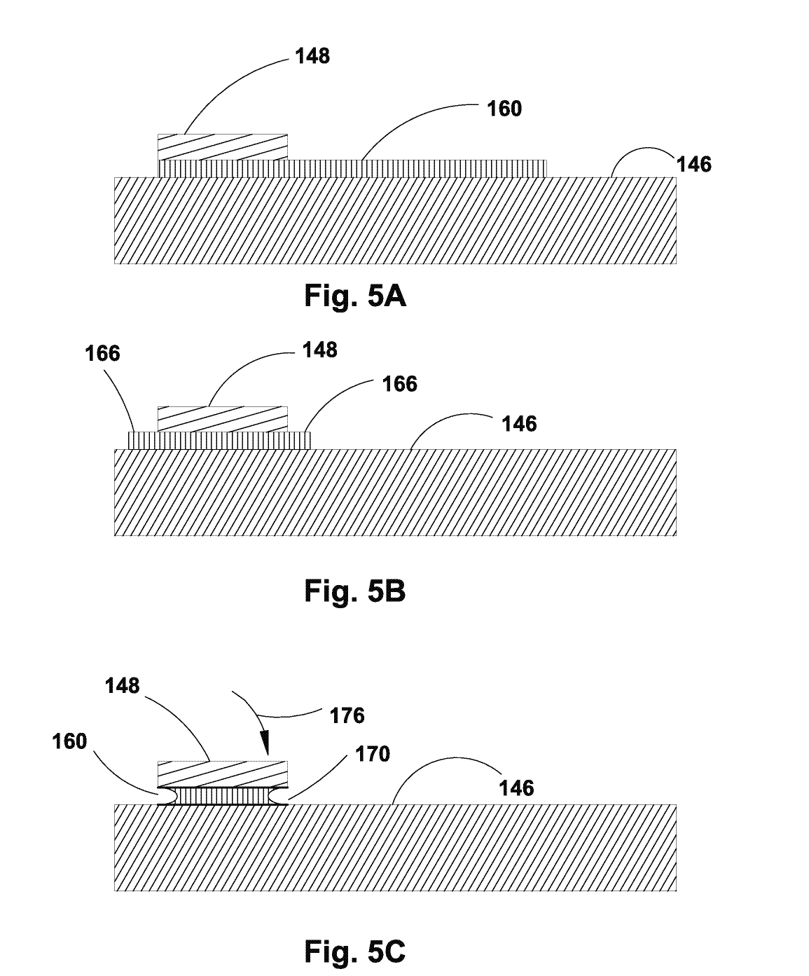

As stated above, the switch of the present invention is manufactured along the lines of surface micromachining technology. To explain the principles and practices of the manufacturing, reference is made first to FIG. 5A-5C. Substrate 146 is the bottom layer, typically made of silica, alumina, glass, or silicon. Above it, an adhesion layer 160, shown somewhat exaggerated in breadth and thickness, is deposited. A metal layer in the form of patch 148, at least two function as contact pads, is deposited. It is a particular feature of a switch of the present invention that the adhesive layer 160 subtending the metal layer or patch 148 is etched, as can be seen in FIG. 5B, leaving an extended adhesive layer margin 166 around the metal patch 148 on the surface of substrate 146.

To visualize the effect of over-etching, reference is made to FIG. 5C. Cavity 170 is formed as a result of over-etching, a phenomenon that might be detrimental to the mechanical stability of the metal layer or patch 148 as it is fixed on an anchor. Arrow 176 indicates the force that may be applied by proof mass 22 that is attached to metal patch 148, upon occurrence of acceleration.

The Gap Between Metal and the Substrate

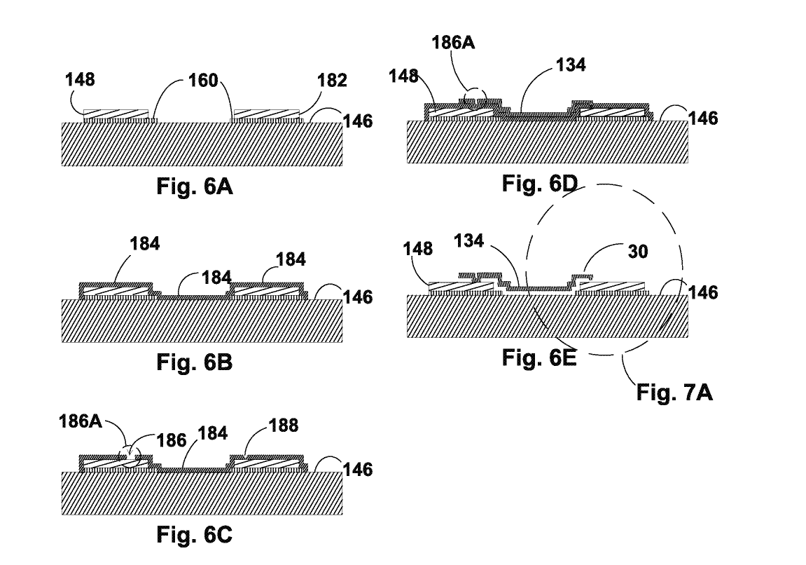

In order to produce differential distances between the components of proof mass module and the substrate and substrate borne contacts, several approaches are employed. One such approach is described with reference to FIGS. 6A-6E. In FIG. 6A substrate 146 accommodates two metal patches 148 and 182. Each of the metal patches 148 is attached to substrate 146 through adhesive layer 160. Then, as can be seen in FIG. 6B, sacrificial layer 184 is deposited over the substrate. In FIG. 6C, sacrificial layer 184 is shown etched in two specific recesses 186 exposing metal layer patch 148 at site 1 86A, and a depression 188, typically considerably smaller and shallower than recess 186.

In FIG. 6D proof mass module 134 is deposited or electroplated so that it is connected to metal patch 148 at site 186A coinciding with recess 186, and in FIG. 6E, the sacrificial layer is completely removed showing the connection of proof mass module 134 to contact pad or metal patch 148. Contact lingule 30 is shown at the right side of the proof mass module 134, and it will be discussed in more detail next.

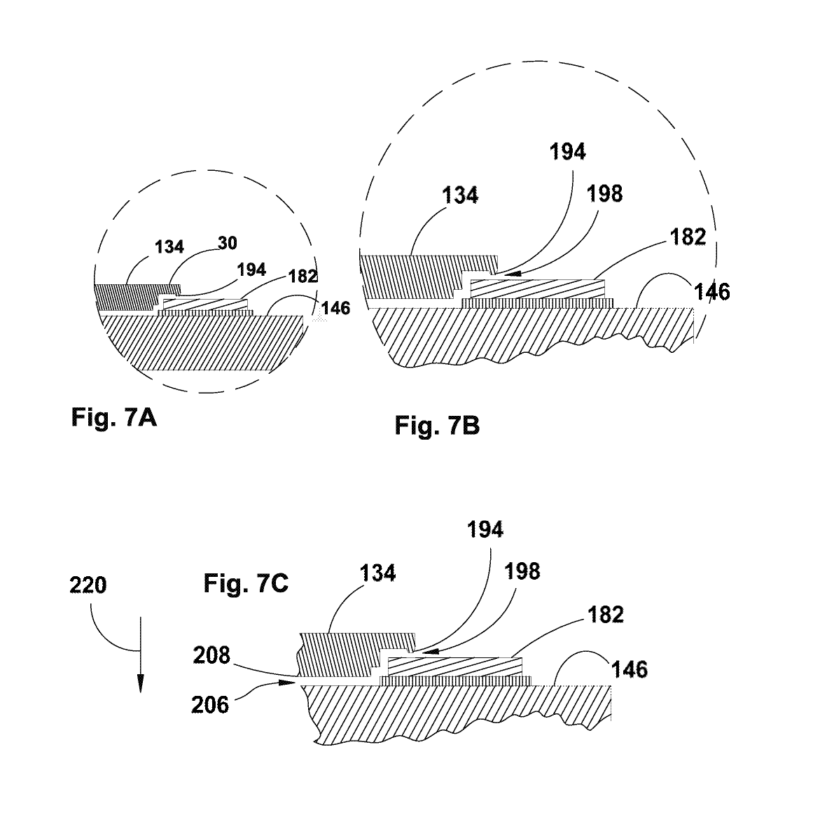

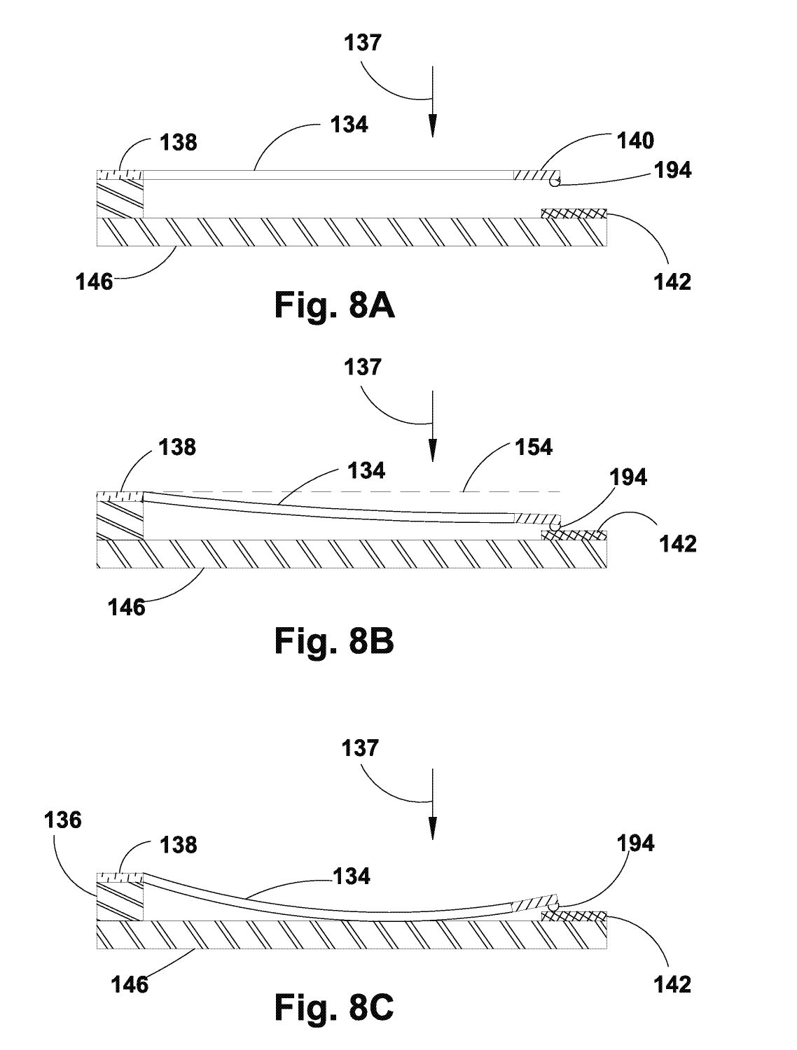

Reference is now made to FIG. 7A in which contact lingule 30 of proof mass module 134 is shown bearing bulge 194 that points at contact pad 182. In FIG. 7B which is an enlarged version of FIG. 7A, the gap between bulge 194 and pad 182 is designated 198. Since the bulge 194 was deposited inside sacrificial layer 184, it is closer to contact pad 182 than the bottom of proof mass module 134 is to substrate 146. Referencing FIG. 7C, gap 206 between bottom face 208 of module 134 and the top of substrate 146, is wider than gap 198. When an acceleration event takes place, proof mass module 134 is urged in the direction indicated by arrow 220 and before the bottom face 208 reaches the top of substrate 146, bulge 194 abuts contact pad 182, closing an electrical circuit. The function of the lingule 30 and the bulge 194 it bears is explained in more detail with reference to FIGS. 8A-8C. In FIG. 8A, the acceleration switch is seen at the onset of an acceleration event indicated by arrow 137, i.e. module 134 is straight, and substantially parallels the top side of substrate 146. Contact lingule 140 and the bulge 194 disposed beneath face contact pad 142. In FIG. 8B, after the onset of the acceleration, module 134 moves towards substrate 146 while bulge 194 abuts contact pad 142, and urges against it. In FIG. 8C, the urge in the direction of arrow 137 still continues, and if the force in that direction is strong enough, module 134 can curve as far as to urge against substrate 146, while bulge 194 continues to press against contact pad 142, even more forcefully, ensuring the continued metal to metal contact. Thus, a current can pass between contact pad 138, module 134 lingule 140, bulge 194 and contact pad 142.

Packaging

The reliability and shelf life of the switch produced in accordance with the invention is improved if the switch is sealed preventing atmospheric contact while the ambient gas is clean and dry, with outside atmospheric contaminants prevented from entering the casing in which the switch is disposed. Gluing with cold curing is a preferred method for sealing the casing that can thereafter keep the switching device isolated from the outside atmosphere. This isolation prevents the penetration of moisture inside the casing which may cause deterioration of the switch and its function. Water vapor once inside the casing can condense, especially on cold surfaces and cause corrosion and current leaks in the presence of ions. Water vapor may also accumulate to form liquid water in places where it could exert capillary forces on the switch and thence change the switch parameters. If soldering is used to seal the casing, heat is produced which may distort the casing, which may in turn decrease the alignment of casing planes, reducing thus the hermetic nature of the closure. The production of heat in such a context may lead also to deformation of the switch itself, which may also alter its parameters. Cold curing of the glue is better than hot curing because of the same reason discussed above. Silicone glue was found to a favorable glue option in this case. It also required that the sealing of the package (by gluing) is made under controlled atmospheric condition to prima facie exclude water vapor and dirt particles which may be detrimental to the quality of the switch.

Corrugated PMSs

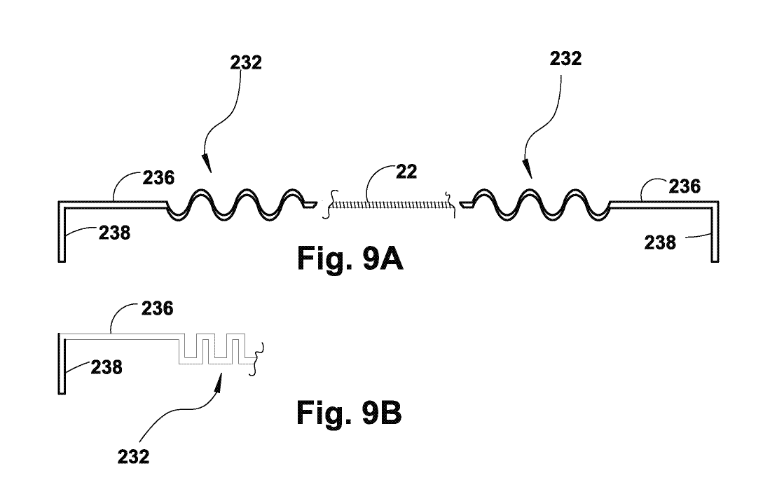

In some embodiments of the invention, some or all the PMSs are corrugated in some or all of their length. To explain this structural and functional property, reference is made to FIGS. 9A-9B. A view of a cross section across a switch of the axially symmetrical constrained type is shown, indicating corrugated zones 232, non corrugated zones 236 and the proof mass 22. Legs 238 of the PMS are connected to electrical contacts on anchors (not shown). The corrugations in FIG. 9A are undulating and the corrugations in FIG. 9B are substantially square in section. The corrugations are not necessarily a priori confined to a specific zone on the PMSs, and their shape may be varied. The inclusion of corrugation a design of the PMS is contemplated as serving two distinct purposes. One effect of the corrugated design is to decrease the effect of thermal divergence. The folding/unfolding effect of the corrugations decreases the dislocation of the proof mass in response to changing temperature effects. The other purpose is to accommodate the switch to duty in higher acceleration ranges for example by using a higher stiffness (resistance to deformation) of corrugated PMS. Corrugations can be applied in both variants of the switch of the invention.

What is claimed is:

1. An acceleration responsive switching device formed as a micro-electromechanical systems (MEMS) device in which components are deposited and etched on and or above a substrate, comprising:
a proof mass module comprising:
at least one proof mass made of metal;
at least three resilient suspending components made of metal, for suspending said proof mass;
a lingule made of metal, connected to said proof mass;
at least two contact pads to which at least one of said at least three resilient suspending components is permanently attached thereby allowing current to flow from the at least two pads to the proof mass module; and
at least one additional contact pad, which is set against said lingule.

2. The device as in claim 1, wherein said at least three suspending members are arranged around said proof mass in a circularly symmetrical manner.

3. The device as in claim 1, wherein the suspending members are arranged around said proof mass in an axially symmetrical manner.

4. The device as in claim 1, further comprising two electrodes disposed above and beneath the proof mass, without forming contact with the proof mass, wherein the electrodes form an electric field across the proof mass.

5. The device as in claim 1, wherein the device is encased in a casing sealed off using cold curing glue.

6. The device as in claim 5, wherein the cold curing glue is silicone glue.

7. The device as in claim 1, further comprising at least two metal patches, functional as contact pads, which are subtended by an adhesive layer leaving an extended margin around the substrate.

8. The device as in claim 1, wherein at least one of the suspending components is at least partially corrugated.

9. The device as in claim 1, wherein the acceleration is deceleration.
